(19) United States
(12) Patent Application Publication
(10) Pub. No.: US 2016/0031042 A1
(43) Pub. Date: Feb. 4, 2016

(54) ALUMINUM AND COPPER MATERIAL INTERCONNECTION AND METHOD OF PRODUCING SUCH AN INTERCONNECTION

(71) Applicant: KARLSRUHER INSTITUT FUER TECHNOLOGIE, Karlsruhe (DE)

(72) Inventors: Thomas GIETZELT, Karlsruhe (DE); Lutz EICHHORN, Dettenheim (DE); Torsten Wunsch, Weingarten (DE)

(21) Appl. No.: 14/738,641

(22) Filed: Jun. 12, 2015

(30) Foreign Application Priority Data
Jul. 30, 2014 (DE) 102014110777.2

(51) Int. Cl. B23K 31/02; B32B 15/20; B23K 26/24; B32B 15/01

(52) U.S. Cl. CPC B23K 31/02; B32B 15/017; B32B 15/20; B23K 26/24; B23K 2203/10

(57) ABSTRACT

In a material-interlocking connection between aluminum and copper in a layer assembly comprising an aluminum layer disposed on a copper element and a copper layer disposed on the aluminum layer, a weld seam is formed on the top copper layer so as to form a weld which extends through to top copper layer and the aluminum layer into the copper element so as to form in the weld seam an alloy of copper and aluminum.

### BACKGROUND OF THE INVENTION

The invention resides in a material interconnection between aluminum and copper comprising a layer jointure of a copper element and an aluminum layer with a copper layer disposed on the aluminum layer, and also to a method for manufacturing such an interconnection.

Copper as well as aluminum are good electrical conductors and of particular interest with respect to electrical conductors and electrical connections. However, their property profiles, their usability and the advantages of these two metals are not the same. Copper is for example heavier and more expensive and also chemically more durable than aluminum. In applications where large amounts of these materials are needed such as power line applications, both materials are generally used.

A particular application of pairing the two materials is in electromechanical storage systems, and in particular, lithium-ion batteries. Herein, for the interconnection of several individual Li-ion cells whose conductor tabs consist of aluminum need to be permanently connected current busses of copper.

However, aluminum and copper cannot easily be interconnected. Particularly problematic is the formation of a very stable passive layer of with high melting temperature consisting of aluminum oxide which is formed on aluminum surfaces and which, upon removal, forms again spontaneously. In contrast to titanium and titanium oxide the aluminum oxide layer is not soluble in the base material. On one hand, this layer is responsible for the good corrosion resistance of aluminum alloys but, on the other hand, it results in connecting or joining problems and transition resistances during welding. In addition, there are large differences in the thermal, expansion behavior and the melting temperature and there is the tendency to form mixed crystals and intermetallic phases in the copper/aluminum system with again other mechanical, electrical and thermal properties which significantly enhance the formation of internal tensions and local electrical resistances in material interconnections or joints.

Common solutions provide therefore form-lacking or force-locking connections such as plastic deformation joints, clamping connections or screw and bolt connections.

Still, also material interconnections between copper and aluminum are known as well as methods for producing such connections. Generally, these interconnections are established via ultrasound or dot-welding.

In particular, the connection of aluminum tabs to current conductors is not solved in the state-of-the-art in a satisfactory manner. The joining by means of ultrasound can generate grooves at the transition to the non-welded area which may lead to cracks and breakages in those areas. Depending on the pressure molding of the passive layer, the quality of the electrically conductive connection may vary. The quality of dot-welds may also be rather variable and non-uniform depending on process parameters and the state of the materials to be joined by welding.

For example, DE 10 2004 009 651 B4 discloses a method for the welding of aluminum-copper joints by means of laser welding. Before the welding step, an additional material such as preferably nickel or silver or also tin or zinc is placed between the surface of copper-aluminum areas to be joined, preferably in the form of foils or coatings. The additional material reacts during welding as an enriched melt between the two joining partners as the melt has with respect to both partners on one hand an increased solubility and on the other hand avoids direct contact between the two materials and reduces the formation of intermetallic phases.

The present proposal concerns a weld connection between a comparatively massive copper conductor or bus of several millimeter thickness (for example, 2 to 5 mm) and a comparatively thin aluminum conductor tab of a lithium-ion battery which has a thickness in the area of 0.1 to 0.5 mm. With a melting temperature of 660° C. aluminum is one of the metals with a relatively low melting temperature but it has a high oxygen affinity. It has therefore on its surface a firmly adhering passive layer of Al₂O₃, which has a high melting temperature Tₛ=2050° C. When a laser beam hits from above the thin aluminum layer, the layer melts. Immediately, holes are formed in the aluminum layer because of the small thickness of the aluminum conductor and because of surface tension effects of the passive layer, and also because of the much lower melting temperatures of the aluminum in comparison with that of copper (Tₛ=1083° C.). A reproducible electric connection of good qualify can therefore not be achieved by a conventional procedure.

Another problem in connection with laser welding of materials with good electrical and thermal conductivities resides in the fact that—as also described already in DE 10 2001 009 651 B4—those materials, in particular copper, reflect laser radiation of wavelengths in the infrared range to a large extent and absorb only a relatively small part. For laser welding therefore high laser energies must be applied which, however with surface inhomogeneities, which generate local differences in the absorption behavior of the areas to be welded may lead to local overheating. Copper, furthermore, has a particular property that is, its heat absorption is temperature-dependent in that it increases strongly with the transition to a melt.

For the connection to aluminum conductors or tabs of Li-ion batteries furthermore the energy input that can be applied is limited since the aluminum conductors project from the Li-ion battery only by a few centimeters. At the transition to the cell, there is a polymer seal joint with a vacuum tight sealing structure which protects the chemical components of the Li-ion cell in a vacuum-tight manner against the ambient and against oxidation. This sealing structure can be exposed to maximum temperatures of 80° C. for only short periods to ensure the vacuum tightness.

Based hereon, it is the principal object of the present invention to provide a material-locking and crack-resistant connection between different conductor materials, in particular between aluminum tabs and electric busses of copper in Li-ion battery systems.

It is a further object of the invention to provide a method for establishing such a material connection with a high welding speed and a large freedom of the needed cross-sections of the welds with respect to the particular application and the spacing from temperature sensitive areas.

### SUMMARY OF THE INVENTION

In a material-interlocking connection between aluminum and copper in a layer assembly comprising an aluminum layer disposed on a copper element and a copper layer disposed on the aluminum layer, a weld seam is provided on the top copper layer so as to form a weld which extends through to top copper layer and the aluminum layer into the copper element forming in the weld seam, an alloy of copper and aluminum.

In a particular embodiment, the copper layer may for example be nickel-coated. The nickel coating, preferably with a thickness of 1-30 μm serves to affect the alloy composition of the melt by forming a ternary alloy wherein the nickel content is adjustable by choosing the nickel coating thickness. The nickel layer significantly improves the in-coupling of the solid body laser radiation and also the absorption-reflection ratio.

The method for establishing such a material inter-connection between aluminum and copper comprises to provide the components to be welded together, that is, a copper element, an aluminum layer and a copper layer, which are placed on top of one another in the order mentioned to form a component layer arrangement. Then a local welding of the copper element, the aluminum layer and the copper layer is obtained by application of heat from a heat source while forming a weld joint which extends through the copper layer and the aluminum layer into the copper element while the heat of the heat source is applied to the copper layer. Preferably, the procedure is performed under a protective gas cover preferably argon or nitrogen.

The local weld extends over the effective area of the heat-source on top of, and below, the copper layer. If the weld is a dot-weld, a dot-like effectiveness and welding is obtained. Preferably, the local welding is provided by serial heat application of the heat source along a welding line (weld direction) to the copper layer wherein the weld seam, which penetrates the layer assembly follows this welding line. Furthermore, preferably the weld seam cross-section is increased by moving or providing the heat source serially not just along the welding line but by deflecting the heat source from the straight line in a direction transverse to the welding direction. The welding spot is preferably cyclically deflected in a sine or zig-zag form around a center line. The deflection occurs with an adjustable frequency which is obtained utilizing the relationship between activity duration of the heat source and depth of the weld seam which again is usable for the adjustment of the weld depth of the weld seam. The amplitude of the deflection further determines the lateral extension of the weld seam on the copper layer and in the layer assembly.

The top layer or respectively foil has a thickness of preferably 0.1-5 mm and most preferably of 0.2-1.0 mm. The lower temperature melting aluminum layer is sandwiched between copper material which melts at substantially higher temperatures. This facilitates on one hand a better heat distribution and heat dissipation in particular via the top copper layer and, in this way reduces also the probability of selective overheating in the aluminum layer before a joining of the materials and, on the other hand, prevents by means of the copper layer which forms a gas barrier, an influx of oxygen or other gaseous components and an oxidation or the degradation of the aluminum layer. The chances of forming holes, in particular in the aluminum, by local overheating, oxidation or degradation is hereby prevented while a material interconnection between the copper and aluminum components is established.

The material interconnection is obtained preferably by a welding procedure especially by a contact-free laser welding procedure. To this end preferably, plate or fiber lasers with power outputs of more than 1 kW are used.

It is known that laser radiation from solid body lasers with a wavelength of for example 1.06 μm is reflected by copper at room temperature to 95%. In addition, the reflection of copper is highly temperature dependent. At high temperatures and in a copper melt the in-coupling of the solid body laser power increases dramatically. Therefore the copper layer which is directly exposed to the laser radiation is preferably nickel or chrome-coated which reduces the in-coupling problem.

A preferred additional layer of nickel or possibly of chromium, silver or gold on the copper layer which is subjected to the laser radiation, that is, on the surface opposite the aluminum layer, reduces the reflection of the laser radiation and increases the heat in-coupling that is the rate of heat absorption. The additional layer is preferably a material interlocked coating of the copper layer (preferably obtained by galvanic or current-free deposition from solutions or vapor deposition or spattering possibly using thick-film technology) which results in a direct conduction of the absorbed laser radiation in the form of heat into the copper layer. An alternative procedure provides for placing the additional layer in the form of a foil onto the copper layer (that is without material interlocking connection or a connection only via cementing materials such as solder or attachment providers, possibly organic layers such as cement compounds, which increases the laser radiation absorption and, in this way, the heat generation in the layer assembly, but which reduces, that is impairs, the conduction of the heat to the adjacent support surfaces.

The additional layer provides for an inclination of the input laser radiation by 2 to 10°, preferably by 3 to 5° with respect to the orthogonal layer surface and avoids return reflection of the laser radiation which could damage the light conducting fibers in particular of fiber lasers of solid body lasers.

With a continuous welding procedure, the welding speed is preferably 0.1 to 10 m/sec, particularly 1 to 5 m/sec, the deflection of the laser beam transverse to the welding direction is performed with a frequency of 20 to 1000 Hz and preferably 100 to 500 Hz. The laser beam is guided along the welding line and deflected transverse to the center line under the control of additional equipment such as mirror arrangements in a scanner.

Sufficient connection cross-sections for high current transmission capability of an electrical contact location for example for an electrically conductive weld connection in a Li-ion battery can be achieved by deflecting the laser beam in a direction transverse to the welding direction so that a wide weld scam is formed.

Excessive deflection frequencies and welding speeds reduce the heat input required for the locally limited melting of the material layers. The ratio of heat-up temperature over heat-input amount is particularly high if the heat input occurs with a high energy density but only for a short period and locally tightly limited. Hereby, a rapid heating of the layer assembly above the melting temperature of the irradiated area melts the irradiated area before the heat is conducted to the surrounding areas. With an only short-period heat input, the heat is effective to melt the respective material area before it is again cooled in particular by the phase transition during solidification of the material in the weld seam. This basically reduces the thermal load in the vicinity of the weld. A presupposition herefor is the use of small light conducting fibers between 10 to 200 μm, typically with a diameter up to 100 or 50 μm diameter or still smaller diameters with the use of fiber lasers. The diameter of the light conducting fibers should be smaller than the desired welding depth in order to keep the thermal loading of the seam area low and in order to permit an accurate control of the welding depth when the multi-layer arrangement is relatively thin. For very thin multi-layer welding seams, the use of a light conducting fiber diameter of maximally 100 μm is recommended.

In this way, welding seams may be provided in closer proximity to temperature sensitive components as for example a battery cell with a vacuum polymer seal such as a lithium-ion battery.

In a particular embodiment, in addition to the above-mentioned deflection frequencies and welding speeds, the laser radiation is pulsed either by means of a pulsed laser or by deflection and/or blocking means such as mirror elements and/or shutters. With these pulsations, in particular dot welds can be optimized specifically by an increase of the temperature over heat input ratio mentioned earlier. With these radiation inputs of high energy also the structure, in particular the alloying formation and the structural composition generally as well as specifically the grain size, can be optimized.

Laser welding facilitates the efficient manufacture of material-interlocking connections of different metal combinations without a force or form-locking solid body contact such as a screw or bolt connection. Depending on the material combination, melting temperature and heat conductivity, different power densities of laser radiation focused on a welding dot, preferably of a single layer beam are used.

The present invention solves the connection problems present in connections with thin conductor tabs in particular of aluminum as they are present on lithium-ion batteries, to massive current conductors of copper for achieving high voltages or current flows of Li-ion batteries (stacks). The conductive connections consist in principle of the two mentioned different materials aluminum and copper wherein the latter is preferably nickel-coated. In circuit arrangements of several Li-ion cells with these connections the individual cells are interconnected without conventional mechanical connecting means or ultrasound welding. Mechanical connections are subject to aging with increasing transition resistances, in particular in connection with aluminum, as the passive layer becomes thicker or as a result of plastic flowing. An ultrasound welding must ensure a sufficiently material-interlocking and crack-free connection with a certain necessary cross-section. However, in particular in connection with small conductor tab thicknesses at the transition of the used ultrasound transducer, on the support surface of the sheet metal surface, there is an increased danger of crack formation which may not provide for a durable vibration resistant connection as it is required for example when used in motor vehicles.

For use in connection with a Li-ion cell, the preferred material thicknesses are 2 to 5 mm for the current busses of copper (copper element) and 0.1 to 0.5 mm for the aluminum layer disposed on the copper element and the copper layer on top of the Al layer (for example, in the form of foils).

By covering the aluminum layer such as an Al tab with a material which can easily be welded such as in the present case for example nickel-coated copper the formation of holes, as they would form by direct welding of aluminum tabs onto the copper element in accordance with conventional methods, is prevented. Rather, corresponding to the width of the deflection of the laser beam and the welding depth into the copper element, as a result of a mixing of the melt materials and their rapid solidification, in particular at high welding speeds of above 2 m/sec during the laser welding procedure, a ternary alloy of copper, aluminum and nickel is formed. This nickel-containing alloy reduces the chances of crack formation in the weld seam (in contrast to a binary alloy of aluminum and copper alone) and provides, in particular in connection with Li-ion batteries, for a reliable material-interlocking connection of aluminum conductor tabs and copper busses.

The invention will become more readily apparent from the following description of exemplary embodiments thereof described below with reference to the accompanying drawings.

### BRIEF DESCRIPTION OF THE DRAWINGS

FIG. 1 shows schematically, in a cross-sectional representation, a layer assembly comprising a copper layer with nickel coating on an aluminum layer and a copper element joined by a weld seam extending through all elements,

FIG. 2 shows a binary phase diagram Al—Cu and,

FIG. 3 shows a ternary phase diagram Al—CU—Ni.

### DESCRIPTION OF PARTICULAR EMBODIMENTS

The cross-sectional representation of the proposed welding connection of an aluminum sheet 1 to a copper element in the form of a copper plate 2 and a copper layer in the form of a copper sheet 3 disposed on top of the aluminum sheet forming a layer arrangement shows a welding seam 4 which extends through all the layers or sheets of the layer arrangement. It is also shown that the copper sheet 3 on top of the aluminum sheet 1 is provided, at its side facing away from the aluminum, sheet 1, with a nickel coating 5. The nickel coating 5 enhances an absorption of laser radiation 6 applied to the copper sheet 3 as mentioned earlier.

The shown welding connection is an exemplary representation of a connection of an aluminum conductor tab with a copper bus for a lithium-ion battery for use in a motor vehicle. Herefor material thicknesses for the aluminum and the copper sheet of, in each case, 0.2 mm for the copper plate 2 to 4 mm and for the wheel coating of the copper sheet 1 to 5 μm and preferably 5 to 20 μm are mentioned. The laser welding parameters of the single laser beam 6 by which the above-described three-layer material setup was welded, are:
Laser-light power P=1.5 to 3 kW
Welding speed: V=1.5 to 4 m/min
Focal position=−1 mm
scanning weld width ±2 to 4 mm.
deflection frequency of the laser beam: 200 to 350 Hz.

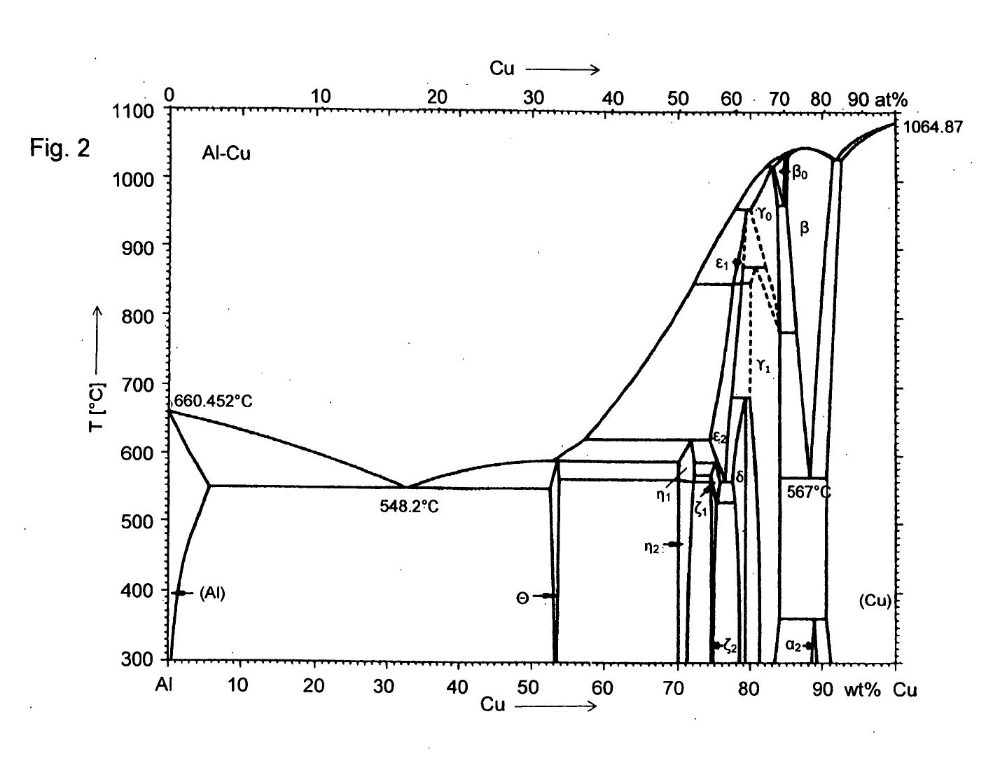

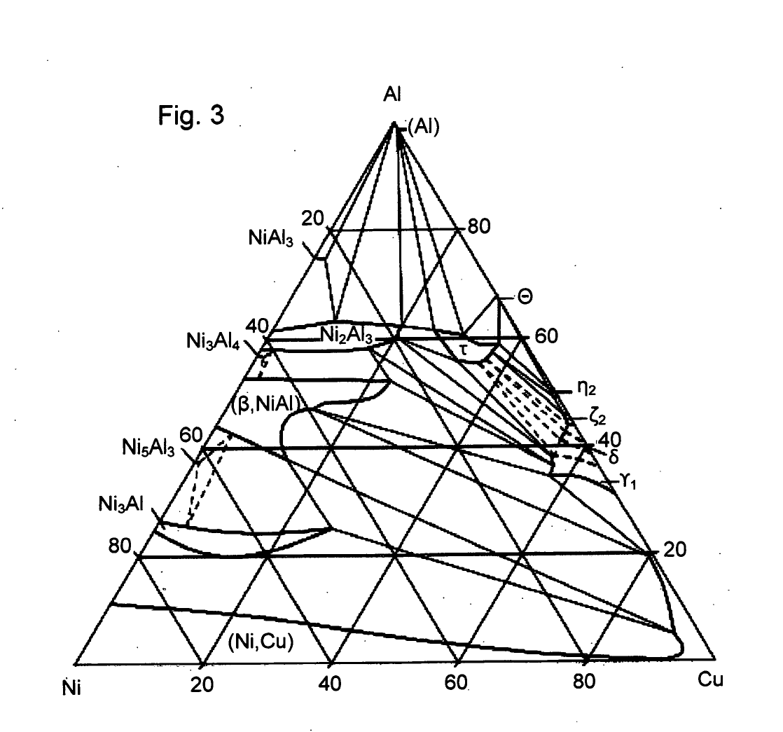

As side effect of the nickel coating, from a binary alloy according to the binary phase diagram Al-Cu of FIG. 2 (binary phase diagram AL—Cu, Lit. [2]), a ternary alloy of the metals Al, Cu and Ni is formed whose composition depends largely on the material thicknesses mentioned above. FIG. 3 shows the phase diagram for the system Al—Cu—Ni (see Landalt-Börnstein, Mew series, Lit. [3]). The composition of the ternary alloy can also be adjusted by controlling the weld penetration depth into the copper element, the thickness of the nickel coating and the thickness of the copper sheet disposed on the aluminum sheet so that brittle phases can be avoided or, respectively, the dynamics of the weld has an adapted morphology with only very thin areas of brittle phases of preferably less than 5 μm which provides for a much reduced crack tendency.

Important is the establishment of sufficiently large interconnecting cross-sections for good current carrying capacity. Also important is the avoidance of a formation of brittle intermetallic phases of Al and Cu in the binary phase system according to FIG. 2. In order to be able to melt at a deflection frequency of more than 2 kHz sufficient amounts of metals with a high heat conductivity and to form a melt bath which has a depth so as to extend through all three material layers, the welding velocity in the welding direction needs to be slow, that is, preferably in the area of 0.5 to 2 m/min. This, on the other hand, enhances the diffusion in the solid state and the formation of brittle, intermetallic phases in the system Al—Cu. A proper selection of the following values is therefore important:
the energy density (defined by the laser power, the diameter of the light conducting cable and the focus position with respect to the surface),
the deflection of the laser beam transverse to the welding direction with a sufficiently long residence time in order to produce a sufficiently large melt bath extending through all layers,
a welding speed, which provides for relatively little diffusion in the solid state areas so that no wide seams of intermetallic phases can form.

It is known that numerous intermetallic phases occur in the binary phase diagram Al—Cu. The welding speed or, respectively, the duration in which material is molten significantly affects the amount, the distribution and the morphology of the intermetallic phases being formed. An excessively long melt duration and high intermixing result in the formation of phases which are close to the phase diagram which corresponds to that representing thermodynamic equilibrium. Non-equilibrium conditions which can be achieved with a relatively high welding speed and which can be frozen in this way, are lost with increasing duration.

The welding seams are examined by light-microscopy on the basis of polished section micrographs with various parameter variations. For closer examination, the samples are polished and etched.

With a laser light power level of P=2 kW, a focus position of 1 mm inside the material, a welding speed of v=3 m/min, a deflection frequency of 250 Hz and a scanning width of 2.5 mm, a sufficient melt depth into the copper element was obtained. A crack formation occurred as a result of an alloying composition without sufficient intermixing with nickel in the melt. A similar result but with increased crack formation was obtained also with a laser light power output of P=1.5 kw, a focal position of 1 mm within the material, a welding speed of v=3 m/min, a deflection frequency of 200 Hz and a scanning width of 3.0 mm.

A good welding seam which was practically free of cracks or with very little crack formation was obtained with the above laser light power and focus position in the material when the welding speed was reduced to v=1.5 m/mm and the deflection frequency was increased to 300 Hz and the scanning width was reduced to 2 mm. Also, with a low power output of P=2.5 kW and otherwise the same parameters, a crack-free welding seam with sufficient welding depth was obtained.

With a laser light power of P=3 kW, a focus position of 1 mm within the material, a welding speed v=4 m/min, a deflection frequency of 200 Hz and a scanning width of 4.0 mm the weld depth was reduced with respect to the previous setting in spite of the higher laser power because of the greater scanning width and scanning speed. It resulted in a massive crack formation because of the alloy composition in the melt.

In all experiments, the respective polished micrographs of the welding seam show a golden coloring which is clearly distinguished from the reddish copper and the silvery aluminum colors and which indicates a sufficient intermixing during the alloy formation.

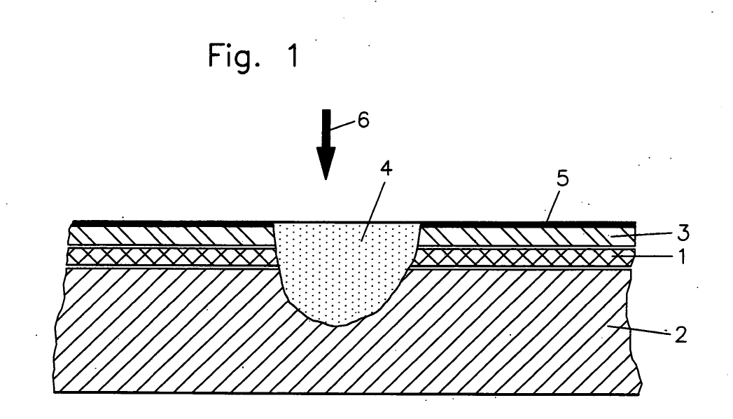

The development of most cracks was observed when the weld seam did not extend sufficiently deep into the copper element 2 (FIG. 1). With the dimensions mentioned above, a sufficient welding depth is achieved when the welding seam extends at least 0.3 to 0.4 mm, that is at least one and a half to twice the thickness of the aluminum layer, into the lower copper element. Under these conditions, alloys with a sufficiently high copper content or formed. All the welding seams were crack-free when the weld had at least this depth.

The welding depth depends on the welding speed, the deflection frequency, the scanning width and the laser power output. In the above experiments, welding seams with little or no cracks were obtained with increased deflection frequencies of preferably 300 Hz, small scanning widths of maximally 2 mm and lower welding speeds of maximally 1.5 m/min, while the laser light power in the range of P=1.5 to 2.5 kW did not appear to have a significant effect on the crack formation and the welding depth. Scan width and welding depth determine the Al content in the melt. The welding depth into the lower copper element has a significant effect on the cupper content in the melt being formed. Cracks occur in particular in areas with lower copper content.

With the welding speed mentioned above of 3 m/min, rough intermetallic phases and cracks develop in the welding zone. A laser beam power of 2 kW is obviously insufficient to melt the material with a scan width of 2.5 mm to a depth sufficient to achieve a high copper content in the melt. Because of the higher welding speed the transition to the Al matrix ends up in a finely graduated but narrow diffusion zone.

If the welding speed is halved to 1.5 m/min, the specific energy input (per travel distance) is doubled resulting in a substantially larger extent of the diffusion of copper in aluminum. While then the morphology at the transition from the melt bath exhibits dendritic growth structures, a net-like structure is formed at the transition to the aluminum. The morphological and material examinations were performed by means of a scanning electron microscope (REM, JEOL 6300) and energy dispersive x-ray spectroscopy (FDX, SUTW—detector Fa. EDAX with an initiation voltage: 20 keV working distance: 17 mm, measuring time: 1 min). These structures differ in the light microscope by different grey values on the etched polished micrograph image. Assuming that during the welding procedure various (intermetallic) phases are formed, the fine branching in the aluminum matrix results in a smaller size scale in a firm interconnection in the ductile Al matrix with a reduced crack formation danger.

A laser radiation power reduction to 1.5 kW is more than compensated for by the 2 mm reduction of the scanning width and the lowered welding speed halved to 1.5 m/mm. The result is a substantially larger welding depth into the copper element and a melt composition with greater copper content.

In the transition area between the weld seam and the aluminum layer, a content of 80 at % Cu and 16.9 at % Al has been found in the alloy. In the binary phase diagram according to FIG. 2, this is at the boundary of the Cu-rich mixed crystal area, that is, there is no intermetallic phase with an increased brittleness. The nickel content is negligible herein (see FIG. 3).

The composition in the dendritic-type zone at the transition from the copper-rich melt bath to the aluminum area has, in accordance with EDX measurements, with 22 at % aluminum and 44 at % copper, a ratio of 1:2 which points to the brittle intermetallic θ-phase (see FIG. 2). The oxygen content with 33 at % however is very high. Assuming that during welding a sufficient protective atmosphere was present, the oxygen must have come from the passive layers of the Al- and Cu materials. The Ni content at this point is negligible (see FIG. 3).

In the interior of the welding seam toward the copper-rich area, there is an atomic ratio Al:Cu of 40:57 which points toward the intermetallic ζ2 an η2 phases (FIG. 2). In a still more copper-rich inner area, an atomic ratio Al:Cu of 11:84 was measured which indicates the α2 phase (FIG. 2). These areas are oxygen-free are oxygen-poor, the Ni-content is negligible (see FIG. 3).

### LITERATURE LISTING

### [1] DE 10 2004 009 652 B4

[2] binares Phasendiagramm Al—Cu:

http://antipasto.union.edu/engineering/Archives/SeniorProj ects/2006/ME.2006/agostina/photos%20from%20project/photopages/p hoto01.htm (Stand28.07.2014)

[3] Landolt-Börnstein, New Series IV/11A2:

http://beta.springermaterials.com/docs/pdf/10915967 7.html?queryterms=%2al-cu-ni%22 Stand:28.07.2014)

What is claimed is:

1. A material interlocking connection between aluminum and copper comprising:
a layer assembly consisting of a copper element (2),
an aluminum layer (1) disposed on the copper element (2), and
a top copper layer (3) disposed on the aluminum layer (1), the interlocking connection being established by a welding seam (4) extending from, and through, the top copper layer (3) through the aluminum layer (1) and into the copper element (2).

2. The material interlocking connection according to claim 1, wherein the aluminum layer (1) is an aluminum sheet or aluminum foil, and the top copper layer (3) is a copper sheet or copper foil disposed on the aluminum layer (1).

3. The material interlocking connection according to claim 1, wherein a layer of nickel in the form of a nickel coating is disposed on the fop copper layer (3) at the side thereof facing away from the aluminum layer (1).

4. The material interlocking connection according to claim 1, wherein the welding seam (4) extends on the upper copper layer (3) along a weld line.

5. The material interlocking connection according to claim 4, wherein the weld line follows a cyclic line around a center line.

6. A method for the manufacture of a material interlocking connection between aluminum and coppery comprising the following steps:
a) providing a copper element (2), an aluminum layer (1) and a copper layer (3),
b) placing the aluminum layer (1) onto the copper element (2),
c) placing the copper layer (3) onto the aluminum layer (1) so as to form a layer assembly, and
d) locally welding the copper layer (3), the aluminum layer (1) and the copper element (2) under heat input by a heat source (6) while forming a weld seam (4) which extends through the top copper layer (3) the aluminum layer (1) and into the copper element (4) so as to form in the weld seam a copper and aluminum alloy.

7. The method according to claim 6, wherein the local welding is performed by serial application of heat by the heat source (6) along a welding line on the top copper layer (3) wherein the weld seam (4) follows the welding line.

8. The method according to claim 6, wherein the heat source (6) oscillates around a center line on the top copper layer (3) with a cyclic deflection frequency of 150 and 500 Hz thereby forming a periodic configuration of the weld seam (4).

9. The method according to claim 6, wherein the heat of the source (6) is applied to the copper layer (3) in a pulsed manner.

10. The method according to claim 6, wherein the heat source (6) is a laser beam.

11. The method according to claim 6, wherein the top copper layer is provided with a nickel coating.
